(19) United States
(12) Patent Application Publication
(10) Pub. No.: US 2002/0122963 A1
(43) Pub. Date: Sep. 5, 2002

(54) Fuel cell installation with integrated gas cleaning and method of cleaning a reformer gas

(76) Inventors: Peter Buchner, Heiligenstadt (DE); Ulrich Gebhardt, Langensendelbach (DE); Gunter Luft, Lauf (DE); Konrad Mund, Uttenreuth (DE); Manfred Waidhas, Nurnberg (DE)

Correspondence Address: LERNER AND GREENBERG, P.A., Post Office Box 2480, Hollywood, FL, 33022-2480, US

(21) Appl. No.: 10/042,081

(22) Filed: Jan. 7, 2002

Related U.S. Application Data
(63) Continuation of application No. PCT/DE00/02173, filed on Jul. 4, 2000.

(30) Foreign Application Priority Data
Jul. 5, 1999 (DE) 199 30 872.1

(51) Int. Cl. H01M 8/04; H01M 8/06

(52) U.S. Cl. 429/13; 429/19

(57) ABSTRACT

A method for cleaning a reformer gas in a fuel cell installation includes the step of passing the reformer gas through at least one fuel cell and electrochemically oxidizing CO in the at least one fuel cell to form CO₂. A fuel cell installation with an integrated gas cleaning is also provided.

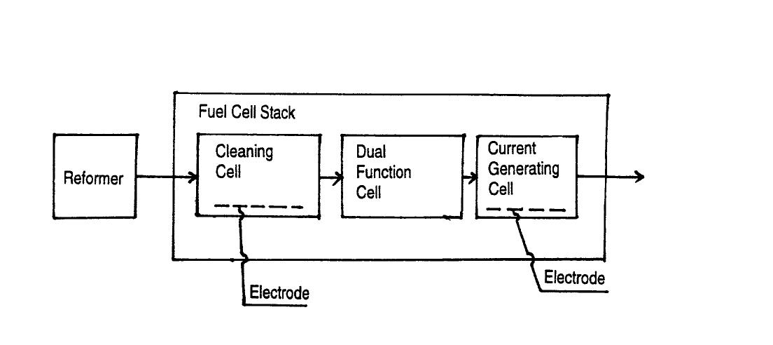

### CROSS-REFERENCE TO RELATED APPLICATION

This application is a continuation of copending International Application PCT/DE00/02173, filed Jul. 4, 2000, which designated the United States.

### BACKGROUND OF THE INVENTION

1. Field of the Invention

The invention relates to a method for cleaning the reformer gas in a fuel cell installation. The invention also relates to a corresponding fuel cell installation with a reformer, a fuel cell stack and an integrated gas cleaning.

In fuel cell installations with a reformer, as are used, for example, in electric traction and in stationary fuel cell installations, which are operated, for example, with natural gas, the fuel, i.e. the reformer gas, always contains a high proportion of CO gas as a result of the reforming process. This CO-containing reformer gas flows onto the anode of the fuel cell, where it leads to catalyst poisoning, in particular at operating temperatures below 100° C. Moreover, the CO level in the reformer gas increases as it passes through the fuel cell stack, since the hydrogen gas which it contains is consumed and the CO content, which is not consumed, rises continuously relative to the hydrogen content. In order to be able to supply current densities which are of interest for technical applications, it is necessary to keep the carbon monoxide content in the reformer gas at a low level.

Methods for cleaning reformer process gas in which the oxidation of the carbon monoxide is carried out in the reformer by increasing the oxygen partial pressure are known. Hitherto, there have been no methods and/or devices for cleaning the exhaust gas (emission prevention) from a fuel cell installation. A drawback of gas cleaning using an increased supply of oxygen is that in mobile systems, such as fuel cell installations for electrical traction, it is either necessary to carry along a relatively large tank or to provide a high compressor output. German Patent No. DE 196 15 562 C discloses a device and a method for the combined cleaning and compression of CO-containing hydrogen, in which the CO in the CO-containing hydrogen is selectively oxidized in a PEM (Proton Exchange Membrane) fuel cell to form CO₂ as a result of a quantity of oxygen which corresponds to the CO content being admixed with the hydrogen. Furthermore, Published European Patent Application No. EP 0 834 948 A2 discloses a device and a method for lowering the concentration of CO in a fuel which is suitable for a fuel cell, in which there is a separate unit for the selective oxidation of the CO, wherein this unit is fed with a gas which has oxidizing properties. The fuel cell stack is connected downstream of this unit, which is part of the reformer.

### SUMMARY OF THE INVENTION

It is accordingly an object of the invention to provide a method for cleaning a reformer gas in a fuel cell installation and an associated fuel cell installation which overcome the above-mentioned disadvantages of the heretofore-known methods and devices of this general type and with which CO can be removed from the reformer gas as process and/or exhaust gas from a mobile or stationary fuel cell installation without having to increase the supply of oxygen.

With the foregoing and other objects in view there is provided, in accordance with the invention, a method for cleaning a reformer gas in a fuel cell installation, the method includes the steps of:

passing a reformer gas through at least one fuel cell; and

electrochemically oxidizing CO in the at least one fuel cell to form CO₂.

According to the invention, a method for cleaning the reformer gas of a fuel cell installation is provided, wherein the reformer gas is passed through at least one fuel cell in which CO is electrochemically oxidized to form CO₂.

With the objects of the invention in view there is also provided, a fuel cell installation, including:

a reformer for providing a reformer gas;

a fuel cell stack connected to the reformer; and the fuel cell stack including at least one cleaning cell for providing an integrated gas cleaning and at least one current-generating cell for generating an electrical current, the at least one cleaning cell electrochemically oxidizing CO to form CO₂ for cleaning the reformer gas.

According to another feature of the invention, the at least one cleaning cell includes an anode having a voltage potential of greater than 0.4 V.

In the fuel cell installation according to the invention, the gas cleaning is integrated in the fuel cell stack, which includes at least one cleaning cell, which is used to clean the reformer gas, and a current-generating cell, which is used to generate current.

In an advantageous embodiment of the invention, the CO is removed from the reformer gas to such an extent that, when the reformer gas flows onto the anode of a current-generating cell, the level of CO in the reformer gas is less than 100 ppm, preferably less than 70 ppm, and particularly preferably less than 50 ppm.

According to another feature of the invention, at least one dual-function fuel cell unit is provided, the at least one dual-function fuel cell unit selectively operates, in dependence on a given voltage applied thereto, as a cleaning cell and as a current-generating cell.

In other words, according to a preferred embodiment of the installation according to the invention, the installation includes at least one device with which at least one cell of a fuel cell stack can be operated both as a cleaning cell and as a current-generating cell. This device includes, by way of example, a current and/or voltage controller, with the aid of which the voltage of the cell is controlled in such a way that at times it primarily converts the hydrogen from the reformer gas flowing in at the anode to form protons and at other times primarily converts the CO to form CO₂. This current and voltage controller is preferably connected, via a control unit, to a gas probe, which determines the current CO partial pressure in the reformer gas line, so that one or more cells of a stack are operated as cleaning cells automatically and/or dynamically, according to given requirements.

According to a preferred embodiment of the method according to the invention, the reformer gas or reformed gas is passed through an exhaust-gas catalytic converter, such as an automotive exhaust-gas catalytic converter. Moreover, the cleaning carried out by one or more cleaning cells can be combined with the cleaning through the use of the exhaust-gas catalytic converter.

Other features which are considered as characteristic for the invention are set forth in the appended claims.

Although the invention is illustrated and described herein as embodied in a fuel cell installation with an integrated gas cleaning and a method of cleaning the reformer gas, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The single figure is a schematic diagram for illustrating an exemplary embodiment of the fuel cell installation according to the invention.

### DESCRIPTION OF THE PREFERRED EMBODIMENTS

A “current-generating cell” includes at least one membrane and/or matrix with a chemically and/or physically bound electrolyte, two electrodes, which are situated on opposite sides of the membrane and/or matrix and which generally include a solid current collector, such as for example a carbon fabric, on which there is a catalyst paste, such as for example a platinum/ruthenium alloy. Adjacent to each electrode there is a reaction chamber, which is closed off from the environment by in each case a terminal plate and/or a suitable edge structure, devices which can be used to introduce and discharge reformer gas into and from the reaction chamber also being provided.

In principle, a “cleaning cell” or purifying cell is constructed in the same way as a current-generating cell, with the exception that it is short-circuited i.e. that the anode builds up a positive potential, so that CO which comes into contact with it is oxidized to form CO₂.

It is indeed possible for a cell to serve at times as a cleaning cell and at times as a current-generating cell. On the other hand, according to one configuration of the battery, one cell of a stack is always used as a cleaning cell. A fuel cell unit which is fixed as the cleaning cell may, for example, be of a different size from the adjoining current-generating cells, and/or it may have a different catalytic coating of the anode, for example a coating including tungsten carbide and/or a coating including platinum. A cleaning cell does not need any reaction space at the cathode, in particular does not need any covering of catalyst at the cathode, and therefore the reaction space at the anode can be increased in size.

According to one embodiment of the battery or fuel cell installation, the anode in a cleaning cell has a potential of greater than 0.4 V, preferably of greater than 0.45 V and particularly preferably of greater than 0.5 V. The conversion of the hydrogen which is contained in the reformer gas and which is converted at the anode in a current-generating cell is inhibited at these potentials, whereas the oxidation of the CO to form CO₂ takes place at this potential.

The current-generating and cleaning cells of a stack may be provided in any desired order. Generally, it will be sensible for the first cell of a stack to be in the form of a cleaning cell. For exhaust-gas cleaning, the last cell of a stack will be in the form of a cleaning cell.

On account of the accumulation of the residual CO content it may also be advantageous for a cleaning cell to be provided in the center of the stack.

There can be any desired number and distribution of the cleaning and current-generating cells. In the case of a battery with a plurality of subsystems, an entire stack of cleaning cells is conceivable.

According to one embodiment of the method according to the invention, at the start, until a predetermined minimum temperature is reached, one or more cells of a stack are short-circuited or operated at reduced voltage, as cleaning cell(s), until an operating temperature of the cell of 100° C. or above is reached, at which temperature the catalyst poisoning by CO is of only minor importance. Then, the short-circuit is eliminated or the voltage applied to this cell is brought up to that applied to the other, current-generating cells, and the cell is used as a current-generating cell during further operation. This is the case in particular with fuel cells which have a relatively high operating temperature, such as the HTM (high-temperature polymer electrolyte membrane) fuel cell.

The term “reformer gas” refers to the gas which leaves the reformer, irrespective of whether it is a fuel cell process gas or a fuel cell exhaust gas. The reformer gas may be cleaned either before it enters the fuel cells stack(s) and/or after it has been converted in the fuel cell stack. Accordingly, the reformer gas can be both gas which is fed to the stack and the fuel cell exhaust gas.

The term fuel cell installation denotes the entire fuel cell system, which includes at least one stack with at least one fuel cell unit, as well as the corresponding process-gas feed and discharge ducts, the end plates, the cooling system with cooling medium and all the fuel cell stack peripherals (reformer, compressor, blower, heating for process-gas preheating, etc.). A process-gas duct may also include an aerating and/or venting duct for periodically cleaning the stack by admitting and discharging and/or admixing gas.

A fuel cell unit includes at least one membrane and/or matrix with a chemically and/or physically bound electrolyte, two electrodes, which are situated on opposite sides of the membrane and/or matrix, adjacent to at least one electrode a reaction chamber, which is closed off from the environment by in each case a terminal plate and/or a corresponding edge structure, wherein devices which can be used to introduce and discharge process gas into and from the reaction chamber are provided.

The term stack denotes the stack including at least one fuel cell unit with the associated lines and at least part of the cooling system.

With the present invention, it is possible to reduce the level of polluting carbon monoxide in the reformer gas of a fuel cell installation without supplying additional oxygen. For this purpose, either an exhaust-gas catalytic converter, which may, for example, be heatable, is connected upstream and/or downstream of one or more fuel cell stacks of a fuel cell installation, and/or at least one fuel cell of a fuel cell stack is operated, at least for a short time, as a cleaning cell, this cell being operated at least under reduced voltage, so that the conversion of hydrogen is inhibited and the electrochemical oxidation of carbon monoxide is promoted.

We claim:

1. A method for cleaning a reformer gas in a fuel cell installation, the method which comprises:
passing a reformer gas through at least one fuel cell; and
electrochemically oxidizing CO in the at least one fuel cell to form CO₂.

2. The method according to claim 1, which comprises reducing a CO content in the reformer gas such that the CO content in the reformer gas is less than 100 ppm when the reformer gas flows onto an anode of a current-generating cell.

3. A fuel cell installation, comprising:
a reformer for providing a reformer gas;
a fuel cell stack connected to said reformer; and
said fuel cell stack including at least one cleaning cell for providing an integrated gas cleaning and at least one current-generating cell for generating an electrical current, said at least one cleaning cell electrochemically oxidizing CO to form CO₂ for cleaning the reformer gas.

4. The fuel cell installation according to claim 3, wherein:
said at least one current-generating cell has an anode; and
said at least one cleaning cell is configured to reduce a CO content in the reformer gas such that the CO content is less than 100 ppm when the reformer gas flows onto said anode of said at least one current-generating cell.

5. The fuel cell installation according to claim 3, including at least one dual-function fuel cell unit having a given voltage applied thereto, said at least one dual-function fuel cell unit selectively operating, depending on the given voltage applied thereto, as a cleaning cell and as a current-generating cell.

6. The fuel cell installation according to claim 3, wherein said at least one cleaning cell includes an anode having a voltage potential of greater than 0.4 V
